(19) United States
(12) Patent Application Publication
(10) Pub. No.: US 2018/0326603 A1
(43) Pub. Date: Nov. 15, 2018

(54) NOSE HAIR CLIPPING DEVICE

(71) Applicant: Nathan Moss, Indianapolis, IN (US)

(72) Inventor: Nathan Moss, Indianapolis, IN (US)

(21) Appl. No.: 15/590,011

(22) Filed: May 9, 2017

(51) Int. Cl. B26B 19/14; B26B 19/16; B26B 19/04

(52) U.S. Cl. CPC B26B 19/148; B26B 19/3873; B26B 19/04; B26B 19/16

(57) ABSTRACT

A nose hair clipping device is a battery powered clipping device with batteries which fit into the bottom of the handle and are secured with a screw on cap. The cutting blade is at the top end of the handle, and is small enough to fit inside a nostril, where the blade spins around, cutting each hair close to the root, when it is powered on. There is a protective cap for the blade, which will prevent the blade from being damaged or getting dirty when not in use. The device is available in different colors to appeal to a variety of tastes.

### CROSS-REFERENCE TO RELATED APPLICATION

The present application is related to and claims priority from prior provisional application Ser. No. 62/332,828, filed May 6, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of grooming devices and more specifically relates to a small, hand-held device structured and arranged to be used for trimming nose hair thereby providing a very efficient way to keep nose hairs controlled, so the user will always appear to be well-groomed.

### 2. Description of the Related Art

Everyone, including women, have hair growing inside their noses. Nose hair becomes more noticeable as we age, making us appear to be less than well-groomed. To avoid embarrassment, scissors can be used to keep the hairs trimmed. Scissors may miss some of the hairs and need to be used frequently in order to prevent the hair from becoming noticeable. Tweezers or wax can also be used, but these are not reasonable alternatives for most of us they cause a great deal of pain. Therefore, a need exists for a specially designed battery-powered device that will be used to make this grooming task much easier and more pleasant to accomplish.

Various attempts have been made to solve the above-mentioned problems such as those found in U.S. Pat. No. D487168 to Dan Hoekstra et al; U.S. Pat. No. D376670 to Mark Bellm; and U.S. Publication No. 20110010941 to Tung Yan Lau et al. This art is representative of personal grooming devices. None of the above inventions and patents, taken either singly or in combination, is seen to describe the invention as claimed.

Ideally, a nose hair trimmer should provide a hand-held, battery operated device structured and arranged to be used for trimming nose hairs which is small enough to be used while away from home, and yet would operate reliably and be manufactured at a modest expense. Thus, a need exists for a reliable nose hair clipping device to avoid the above-mentioned problems.

### BRIEF SUMMARY OF THE INVENTION

In view of the foregoing disadvantages inherent in the known personal grooming art, the present invention provides a novel nose hair clipping device. The general purpose of the present invention, which will be described subsequently in greater detail is to provide a small, hand-held device structured and arranged to be used for trimming nose hairs thereby providing a very efficient way to keep nose hairs controlled, so the user will always appear to be well-groomed.

A nose hair clipping device is disclosed herein comprising a main body formed from a plastic material, and includes a center section, a proximal end section attached to the center section, and a distal end section attached to the center section opposite the proximal end section. The distal end section is sized and adapted to fit within a nostril of a person's nose, and includes at least one aperture adapted to allow hair from a person's nostril to extend into it.

A protective cap member formed from a translucent material is further adapted to be placed over and connected to an outer surface area of the distal end section. The main body forms a hollow interior volume having a cutting mechanism which includes a motor member and a cutting blade formed from stainless steel which is mechanically connected to the motor member and adapted to be rotated by the motor member. The cutting mechanism is connected to an inner portion of the distal end section and is adapted and positioned such that when hair from a person's nostril extends through the aperture of the distal end section it can be cut by the cutting blade.

A power source formed as a battery member is located within the proximal end section and is electrically connected to, and powers the cutting mechanism. A control button is located on an outer surface of the center section and is electronically connected between the power source and the cutting mechanism, and is adapted to control power to the cutting mechanism.

The proximal end section and distal end section are removably attached to the center section via respective interdigitating screw threads. The center section is formed having an hour-glass-shape adapted to allow a user to more securely grip the nose hair clipping device while in use. The distal end section is formed having a thimble-shape and the aperture is a plurality of apertures located only on a side portion of the thimble-shape.

The present invention holds significant improvements and serves as a nose hair clipping device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, nose hair clipping device constructed and operative according to the teachings of the present invention.

FIG. 1 shows a side view illustrating a nose hair clipping device according to an embodiment of the present invention.

FIG. 2 is a front perspective view illustrating a nose hair clipping device according to an embodiment of the present invention of FIG. 1.

FIG. 3 is a back view illustrating the hollow interior volume of a nose hair clipping device according to an embodiment of the present invention of FIG. 1.

FIG. 4 is a perspective view illustrating the internal components of a nose hair clipping device according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a grooming device and more particularly to a nose hair clipping device as used to improve the ability of a user to trim nose hair in an efficient manner.

Generally speaking, nose hair clipping device is a battery powered clipping device with batteries which fit into the bottom of the handle and are secured with a cap that screws on. The cutting blade is at the top of the handle, and is small enough to fit inside a nostril, where the blade spins around, cutting each hair close to the root, when it is powered on. There is a protective cap for the blade, which will prevent the blade from being damaged or getting dirty when not in use. The device is available in different colors to appeal to a variety of tastes.

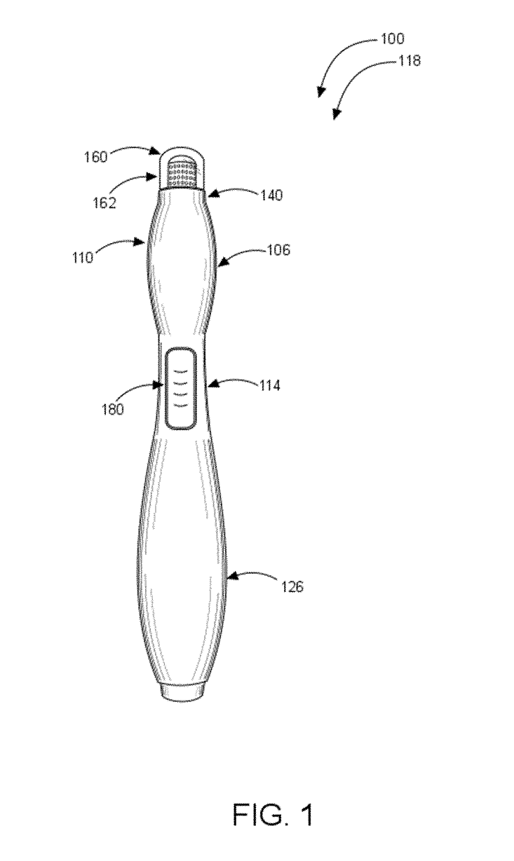

Referring to the drawings by numerals of reference there is shown in FIG. 1, a side view illustrating a nose hair clipping device 100 according to an embodiment of the present invention.

Nose hair clipping device 100 is disclosed herein comprising main body 106 formed from plastic material 110, and includes center section 114, proximal end section 126 attached to center section 114, and distal end section 140 attached to center section 114 opposite proximal end section 126. Distal end section 140 is sized and adapted to fit within a nostril of a person's nose, and includes at least one aperture 144 adapted to allow hair from a person's nostril to extend into it.

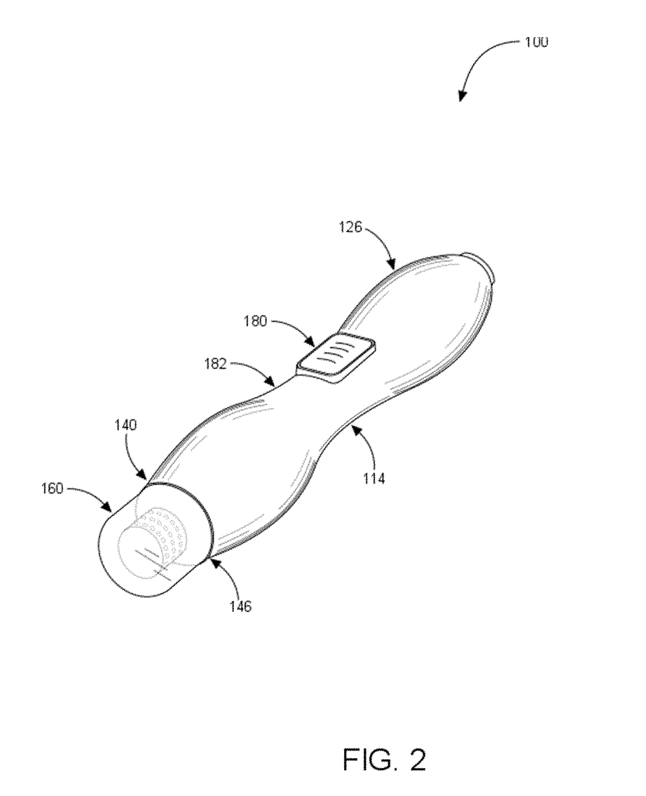

Referring now to FIG. 2, a front perspective view illustrating a nose hair clipping device 100 according to an embodiment of the present invention.

Protective cap member 160 formed from translucent material 162 is further adapted to be placed over and connected to outer surface area 146 of distal end section 140. Main body 106 forms hollow interior volume 108 having cutting mechanism 148 which includes motor member 116 and cutting blade 150 formed from stainless steel 152 which is mechanically connected to motor member 116 and adapted to be rotated by motor member 116. Cutting mechanism 148 is connected to inner portion 154 of distal end section 140 and is adapted and positioned such that when hair from a person's nostril extends through aperture 144 of distal end section 140 it can be cut by cutting blade 150.

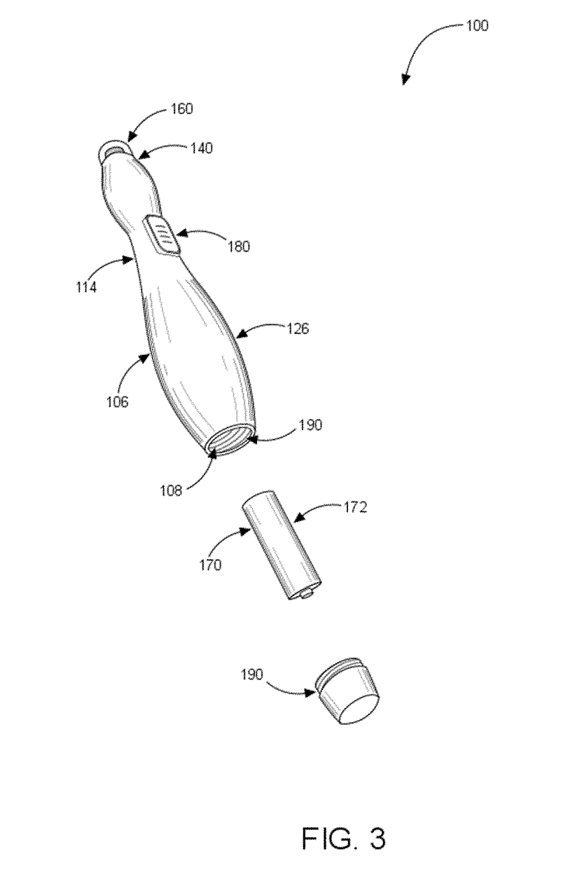

Referring now to FIG. 3, a back view illustrating the hollow interior volume of a nose hair clipping device 100 according to an embodiment of the present invention.

Power source 170 formed as battery member 172 is located within proximal end section 126 and is electrically connected to, and powers cutting mechanism 148. Control button 180 is located on outer surface 182 of center section 114 and is electronically connected between power source 170 and cutting mechanism 148, and is adapted to control power to cutting mechanism 148.

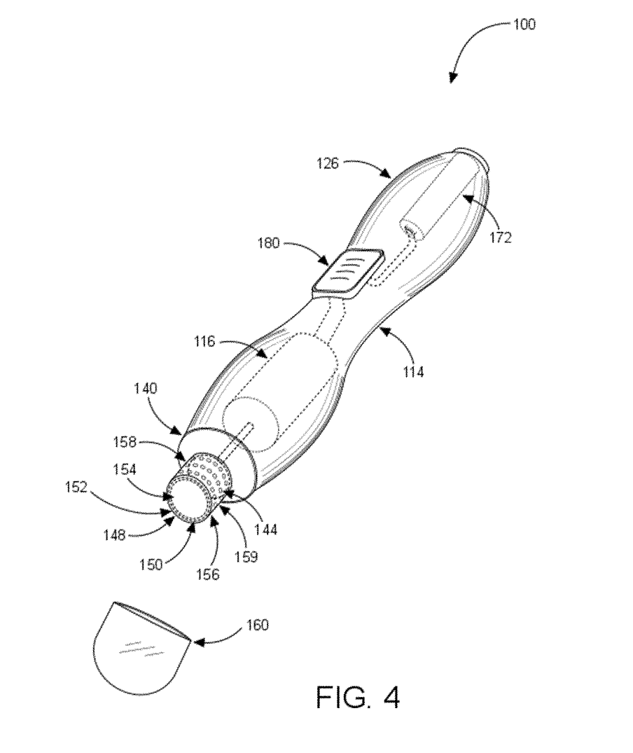

Referring now to FIG. 4, a perspective view illustrating the internal components of a nose hair clipping device according to an embodiment of the present invention.

Proximal end section 126 and distal end section 140 are removably attached to center section 114 via respective interdigitating screw threads 190. Center section 114 is formed having hour-glass-shape 118 adapted to allow a user to more securely grip nose hair clipping device 100 while in use. Distal end section 140 is formed having thimble-shape 156 and aperture 144 is plurality of apertures 158 located only on side portion 159 of thimble-shape 156.

Nose hair clipping device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A nose hair clipping device comprising:
a main body including;
a center section;
a proximal end section removably attached to said center section; and
a distal end section removably attached to said center section opposite said proximal end section, is sized and adapted to fit within a nostril of a person's nose, and includes at least one aperture therethrough adapted to allow hair from a person's nostril to extend therethrough;
wherein said main body forms a hollow interior volume;
a cutting mechanism including;
a motor member; and
a cutting blade;
wherein said cutting blade is mechanically connected to said motor member and is adapted to be rotated by said motor member;
wherein said cutting mechanism is connected to an inner portion of said distal end section and is adapted and positioned such that when hair from a person's nostril extends through said at least one aperture of said distal end section it can be cut by said cutting blade;
a power source;
wherein said power source is located within said proximal end section and is electrically connected to and powers said cutting mechanism; and
a control button;
wherein said control button is located on an outer surface of said center section and is electronically connected between said power source and said cutting mechanism and is adapted to control power to said cutting mechanism.

2. The nose hair clipping device of claim 1, further comprising a protective cap member adapted to be placed over and releasably connected to an outer surface area of said distal end section.

3. The nose hair clipping device of claim 1, wherein said a proximal end section is removably attached to said center section via respective interdigitating screw threads.

4. The nose hair clipping device of claim 1, wherein said a distal end section is removably attached to said center section via respective interdigitating screw threads.

5. The nose hair clipping device of claim 1, wherein said center section is formed having an hour-glass-shape adapted to allow a user to more securely grip said nose hair clipping device while in use.

6. The nose hair clipping device of claim 1, wherein said power source is formed as a battery member.

7. The nose hair clipping device of claim 6, wherein said battery member is a AA battery member.

8. The nose hair clipping device of claim 1, wherein said main body is formed from a plastic material.

9. The nose hair clipping device of claim 1, wherein said cutting blade is formed from stainless steel.

10. The nose hair clipping device of claim 1, wherein said distal end section is formed having a thimble-shape; and wherein said at least one aperture is a plurality of apertures located only on a side portion of said thimble-shape.

11. The nose hair clipping device of claim 1, wherein said protective cap member is formed from a translucent material.

12. The nose hair clipping device of claim 5, wherein said control button is located in the middle of said hour-glass-shape of said center section.
